(19) United States
(12) Patent Application Publication
(10) Pub. No.: US 2019/0121320 A1
(43) Pub. Date: Apr. 25, 2019

(54) APPARATUS AND METHOD FOR ADAPTING A NUMERICAL CONTROLLER TO A MACHINE TO BE CONTROLLED

(71) Applicant: SIEMENS AKTIENGESELLSCHAFT, 80333 München (DE)

(72) Inventors: BENJAMIN MAY, Renningen (DE); ANDREAS POLZ, Erlangen (DE); HENNING RUDOLF, Nürnberg (DE); REINER SPERLICH, Ulm (DE)

(73) Assignee: SIEMENS AKTIENGESELLSCHAFT, 80333 München (DE)

(21) Appl. No.: 16/094,757

(22) PCT Filed: Apr. 12, 2017
(86) PCT No.: PCT/EP2017/058725

§ 371 Date: Oct. 18, 2018

(30) Foreign Application Priority Data
Apr. 19, 2016 (EP) 16166018.8

(51) Int. Cl. G05B 19/408

(52) U.S. Cl. CPC G05B 19/4083; G05B 2219/36089; G05B 2219/34202

(57) ABSTRACT

An apparatus for adapting a data structure between a numerical controller and a machine includes a data acquisition logic unit connected to the machine for acquiring values of machine parameters characteristic of a machine state. The data acquisition logic unit includes an interface module containing rules which are used to transform a machine data structure of the values of machine parameters into a control data structure which can be read by the numerical controller. In a corresponding method, values of the machine parameters which occur in a first machine state are transmitted to the data acquisition logic unit and stored therein. The machine state is assigned to the stored values of the machine parameters as at least one rule for interpreting the values of the machine parameters.

The present invention relates to an apparatus and to a method for adapting a numerical controller to a machine in terms of data, wherein the numerical controller comprises a data acquisition logic unit which is connected to the machine via a data connection for the purpose of acquiring values of machine parameters which are characteristic of a machine state.

A device for controlling a machine which reads control commands from a data carrier and converts the same into work and/or motion sequences of the machine is referred to as numerical control (NC). Nowadays a numerical controller is in most instances equipped with a computer, which prepares the control commands present in the form of a computer program for the corresponding work or motion sequences of the machine. For the control programs, with which a series of various motion sequences of the machine can be predetermined, standardized programming languages exist, with which the sentence and address structure of the numerical control information to be transmitted is defined. A program which has been produced in accordance with the standard can therefore be processed on various numerical controllers. The adaptation of the generally predetermined control commands of the control program to the specific machine is carried out by way of a special data logic.

Three essential function groups can be classified for a numerical controller: the COM part, the NC core and the adaptation control.

The COM part is used for communication tasks with the connected peripheral equipment, such as for instance input and output modules, sensors, end switches and suchlike.

Furthermore, the COM part fulfills the communication tasks with an operator in a human-machine interface and for a programmer in a programming environment, which comprises at least one program editor, often however also simulation and test facilities.

The NC core contains the main functionality of a numerical controller, in other words for instance for a machine tool the route control and interpolation and therefore the generation of motion target values. Tracking these movements is generally carried out by means of a position control.

The adaptation control is used to adapt the numerical controller to specific machine types. Here machine-related connections are realized on the basis of Boolean variables and basic functions. The adaptation control is connected to actuators and sensors in the machine. Actuators in the machine are actuated by way of the adaptation control and signals or states of sensors in the machine are acquired and possibly also processed. In present-day numerical controllers, the adaptation control is often realized with a PLC (programmable logic controller), which operates in the manner of a programmable logic controller.

The design and function of numerically controlled machines are likewise versatile, such as produced by various manufacturing technologies. Numerically controlled drilling machines, milling machines, turning machines and grinding machines are therefore used in modern production, for instance. Special machines according to the type of workpiece, such as for instance interlocking milling machines, crankshaft machining machines and tool grinding machines are also indispensable in modern production. All these machine types require an individual adaptation to the numerical controller. The numerical controller is adapted to the numerically controllable machine by way of a corresponding adaptation control.

The differences in design and function of the various machines are also reflected in the communication between the numerical controller and the machine. Communication with the data acquisition logic unit of the numerical controller is carried out via binary input and outputs of the machine to be controlled. On account of the different work sequences in the various machine types, the data structure for the communication generally differs accordingly. General machine states nevertheless also exist, which are the same in many machine types. This includes for instance states such as “machine produced”, “fault”, “maintenance active” etc. These machine states are acquired during operation of the machine and with their occurrence or non-occurrence effect actions and/or notifications provided accordingly by the control program. There are accordingly information contents between the numerical controller and the controlled machine, which in the case of many machines have a similar meaning or a similar semantic in spite of a different data structure.

The object underlying the present invention is to specify a numerical controller, which can be adapted easily to a specific machine.

The object underlying the invention is likewise to specify a method, by means of which a numerical controller can be adapted easily to a specific machine.

The object mentioned first is achieved by an apparatus having the features of claim 1. Accordingly the data acquisition logic unit of the numerical controller cited in the introduction comprises an interface module. The interface module contains rules, by means of which a machine data structure of the values of machine parameters is transformed into a control data structure which can be read by the numerical controller. It is therefore possible to flexibly transform various machine data structures into a generally valid control data structure. The flexibility is realized via software by way of rules. The control data structure of the parameters which describe a machine state can follow a standard data format or even a standardized data structure, For instance, valid machine states which are transformed by means of the rules and forwarded to the controller generally apply to different machines.

Advantageous embodiments of the apparatus are specified by the features of claims 2 to 6.

According to the features of claim 2, the interface module comprises an interpreter. A realization of this functionality with an interpreter is advantageous in that in each case a currently occurring item of machine data is processed directly by the interpreter with its system of rules. If there is a rule for this item of machine data, a transformation of the machine data structure into the control data structure is carried out without changing the semantics. The use of an interpreter in the interface module can ensure that the logic of the rules is decoupled from the control code and that the machine code is not changed. As a function of the values of the machine parameters, the interpreter determines the machine state using the rules. In this process an occurring item of machine data is compared with the system of rules by the interpreter. If there is a suitable rule, a transformation of the control data structure is carried out in accordance with the rule without changing the semantics.

According to the features of claim 3, the interpreter comprises plug-in mechanisms of the rules for the purpose of interpreting and preparing the data of machine parameters. Various machine types can therefore be adapted easily to the numerical controller via corresponding plug-ins, which predetermine the machine-specific rules for transforming the data structures.

One particularly advantageous embodiment is produced by the features of claim 6. Accordingly, the machine to be controlled is embodied as a machine tool. The machine tool comprises binary inputs/outputs for producing and also reporting a specific machine state. Control signals are supplied to the actuators in the machine tool by way of the inputs for their operation. Signals of sensors in the machine tool are provided to the numerical controller by way of the outputs. Various machine tools can therefore be adapted easily to a universal numerical controller independently of the manufacturing technology implemented therein.

The second object mentioned is achieved by a method having the features of claim 7. Accordingly, the method for adapting the numerical controller cited in the introduction to the machine cited in the introduction in terms of data comprises the steps:
moving the machine to be controlled into a respective machine state,
transmitting the values of the machine parameters occurring in the respective machine state to the data acquisition logic unit,
storing the values of the machine parameters occurring in the respective machine state in the data acquisition logic unit and
allocating the respective machine state to the respectively stored values of the machine parameters as at least one rule for interpreting the values of the machine parameters.

The method enables rules for transforming the data structures by recording and describing the actual data to be automatically learnt by the numerical controller. A machine operator need not therefore concern himself with which values of the machine parameters are characteristic of a specific machine state. The machine operator moves the machine consecutively into the relevant states and in each case stores the combination of values of the machine parameters which occur in the process. The semantics or the semantic content is defined by the predetermined machine states. The learnt rules can now be applied automatically in everyday operation, in order to identify the corresponding states.

Advantageous embodiments of the inventive method are characterized by the features of claims 8 and 9.

The afore-described properties, features and advantages of this invention as well as the manner in which they are achieved will become clearer and more comprehensible in conjunction with the following description of the exemplary embodiments, which are explained in more detail in conjunction with the drawings, which show, in a schematic representation:

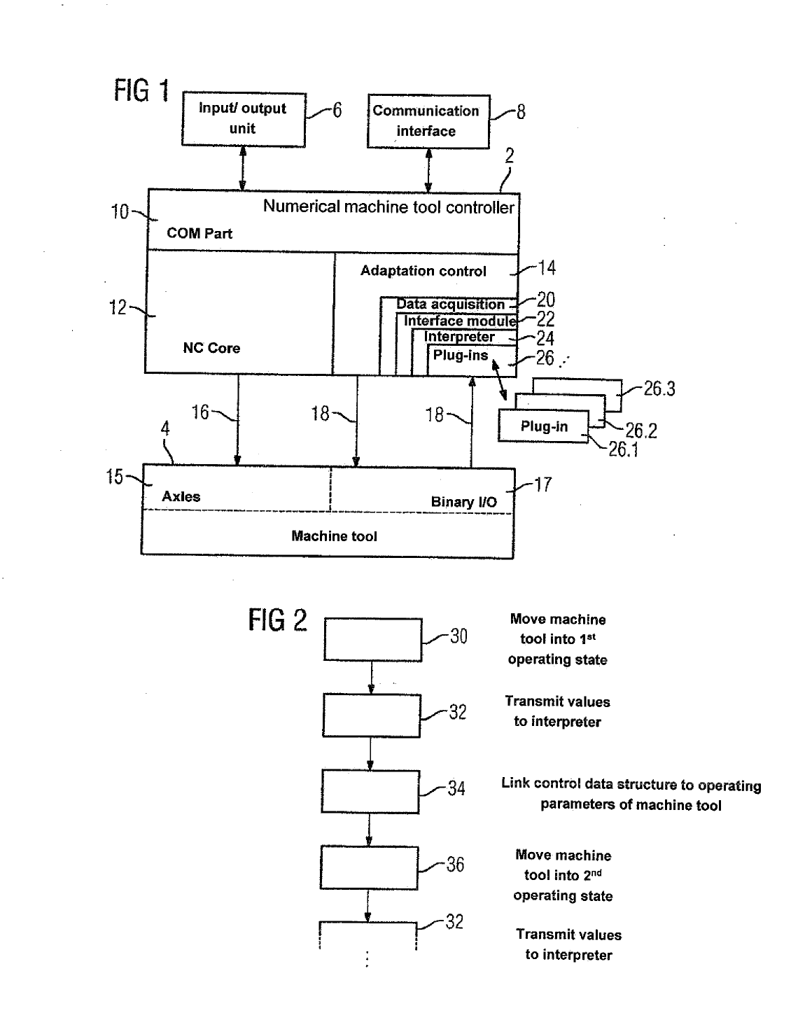

FIG. 1 a block diagram of the design of a numerical controller having a machine tool controlled therewith and

FIG. 2 the essential method steps of a method for generating rules for transforming machine tool data into control data.

The block diagram in FIG. 1 shows a numerical machine tool controller 2, which interacts with a machine tool 4 in order to process a workpiece. Access by a user or operator to the machine tool controller 2 is carried out by way of an input/output unit 6, which is also referred to as NC control panel. In addition, a communication interface 8 is also provided, which allows the numerically controlled machine tool 4 to be embedded in a computer network. This function is referred to in English as Distributed Numerical Control (DNC).

The machine tool controller 2 is classified into three main areas. A first main area, the COM part 10, fulfills communication tasks with connected peripheral equipment, such as, for instance, input and output modules, sensors, end switches and suchlike. Furthermore, the COM part 10 serves to communicate with the input/output unit 6. It moreover makes a programming environment available, which comprises at least one program editor, but often also simulation and test facilities.

The main functionality of the machine tool controllers 2, in other words a route control and interpolation and therefore the generation of motion target values for the machine tool 4, is realized in an NC core 12.

Finally, the third main functionality of the machine tool controller 4 realizes an adaptation control 14, which serves to adapt the general motion controller, relating to the workpiece, from the NC core to the specific machine tool 4.

The connection of the machine tool controller 2 to the machine tool 4 for data or signaling purposes is carried out with respect to the motion target values for the axles 15 of the machine tool 4 by way of first control lines 16 and with respect to the actuators and sensors in the machine tool 4 by means of second control lines 18 via binary input/outputs 17.

Machine-related connections based on Boolean variables and basic functions are realized in the adaptation control 14. This includes the activation of actuators, the detection of sensor signals, the realization of monitoring functions, the safeguarding of safety functions etc. Here simple logical links to the point of sequence controllers with time and counting functions are realized. To this end, control commands of the control program running in the NC core 12 are further processed for the machine tool 4. For instance, T and M commands from the G code are adapted here to the specific machine tool 4 and converted into corresponding control signals.

In conventional numerical controllers, the adaptation control 14 is realized by means of a programmable logic controller. According to the exemplary embodiment of the invention described here, the present adaptation control 14 comprises a data acquisition logic unit 20, by way of which all machine parameters which are characteristic of the various machine states are evaluated and prepared for the program sequence in the NC core 12. These state signals are forwarded to the input/output unit 6 and to the communication interface 8, where applicable.

The data acquisition logic unit 20 comprises an interface module 22 with rules, by means of which a machine data structure of a combination of values of the machine parameters is transformed into a control data structure which can be read by the numerical controller 2. Here the aim of the transformation is to transform the various machine data structures particular to each machine tool type by retaining the semantics in standardized control data structures.

The term data structure is to be understood here to mean data elements and/or further data structures, which are logically linked, and which are combined to form a larger unit under a shared name. A data structure describes the type of organization of the data when data is transmitted and when it is processed in a computer.

The interface module 22 comprises an interpreter 24. The interpreter 24 transforms the machine data structure by means of the implemented rules into the control data structure. The rules for the transformations are stored in a plug-in 26, 26.1, 26.2, 26.3 characteristic of each machine tool. This is advantageous in that the adaptation control 14 can only be adapted to the specific machine tool type by receiving the plug-ins 26 characteristic of the machine tool 4. With another machine tool type, the machine tool controller 2 is adapted to the specific machine tool for instance by means of the corresponding plug-in 26.1 or 26.2 or 26.3 etc. The plug-ins 26.1, 26.2, 26.3 etc. can be stored in a library, for instance.

FIG. 2 shows a block diagram of a method for generating rules for the purpose of transforming machine tool data into control data. To this end, in a first method step 30, the machine tool 4 is moved into a first operating state via the input/output unit 6, whereto a first rule is to be produced for transformation purposes. The machine can also be activated by way of remote access in the form of an app. An app is to be understood as application software (also application program) for mobile devices such as smartphones and tablet computers, whereby a useful or desired user-oriented functionality is provided and supported. This user-oriented functionality exists here in the control of the machine.

The values of the machine parameters which result from the first operating state are transmitted in a second method step 32 via the second control lines 18 to the interpreter 24 in the data acquisition logic unit 20 and stored there. Similarly to the predetermined first operating state, the interpreter 24 receives a first item of control data which can be read by the machine tool controller 2, to which the item of machine data, which occurs and describes the machine state, is to be assigned.

After releasing the operator, the control data structure of the predetermined operating state which can be read by the numerical controller is linked to the values of the values of the operating parameters to be set in the machine tool 4 in a third method step 34 to form a first rule.

The first rule has therefore been learnt by the interpreter 24, by a specific machine state having been assigned to a current actual data record.

The machine tool 4 in method step 36 is thereupon moved into a second state, in which accordingly another combination of the values of the operating parameters is set. Similarly to the method steps 32 and 34, a second rule is created relating to the second state.

The method steps cited above are run through until all generally occurring operating states fulfill the rules required for data transformation. These rules which are valid for the corresponding machine tool type are stored in the plug-in 26.

The rules produced as above can also be used again for the same machine tools 4 directly for adapting the numerical controller 4. It is therefore possible to produce a complete library of plug-ins 26, 26.1, 26.2, 26.3 etc. as described above. In order to adapt to a specific machine tool, only one of these plug-ins 26, 26.1, 26.2, 26.3 needs then to be loaded into the interpreter 24.

If the plug-in library is not to contain any plug-in 26, 26.1, 26.2, 26.3 characteristic of a specific machine tool, a commissioner of the machine tool can adapt the machine tool controller 2 described on the basis of FIG. 1 without knowledge of the specific values of the machine tool parameters at least for generally valid states of the machine tool 4 to the machine tool controller 2 using the method described on the basis of FIG. 2. This is carried out easily by corresponding rules being created from the occurring actual values of the machine tool parameters.

What is claimed is:

1.-9. (canceled)

10. Apparatus for adapting a data structure between a numerical controller and a machine, the apparatus comprising:
a data acquisition logic unit connected to the machine via a data connection and acquiring values of machine parameters that are characteristic of a machine state, said data acquisition logic unit comprising an interface module containing rules describing a transformation of a machine data structure having the values of the machine parameters into a control data structure having a format is readable by the numerical controller, said interface module comprising an interpreter with a plug-in mechanism containing the rules for interpreting and processing data of the machine parameters.

11. The apparatus of claim 10, wherein the machine is a machine tool.

12. The apparatus of claim 10, wherein the machine comprises actuators and sensors, wherein the values of the machine parameters represent states of the actuators and sensors.

13. A numerical controller, comprising:
an adaptation control comprising a data acquisition logic unit, said data acquisition logic unit being connected to a machine via a data connection and acquiring values of machine parameters that are characteristic of a machine state, said data acquisition logic unit comprising an interface module containing rules describing a transformation of a machine data structure having the values of the machine parameters into a control data structure having a format that can be read by the numerical controller, said interface module comprising an interpreter with a plug-in mechanism containing the rules for interpreting and processing data of the machine parameters.

14. A method for adapting a data structure between a numerical controller and a machine, wherein the numerical controller comprises a data acquisition logic unit which is connected to the machine via a data connection and acquires values of machine parameters that are characteristic of a machine state, said method comprising:
moving the machine to be controlled into a respective machine state;
transmitting the values of the machine parameters of the respective machine state to the data acquisition logic unit;
storing the values of the machine parameters of the respective machine state in the data acquisition logic unit; and
assigning the respective machine state to the stored values of the machine parameters as at least one rule for interpreting the values of the machine parameters.

15. The method of claim 14, wherein the data acquisition logic unit comprises an interpreter containing the at least one rule for interpreting and processing the values of the machine parameters, with the interpreter determining the machine state dependent on the values of the machine parameters by way of the at least one rule.

16. The method of claim 14, further comprising adapting the data structure between the numerical controller and the machine when the numerical controller and the machine to be controlled are commissioned.
